(19) United States
(12) Patent Application Publication
(10) Pub. No.: US 2005/0114879 A1
(43) Pub. Date: May 26, 2005

(54) Monitoring signal quality on a cable network

(75) Inventor: John Kamieniecki, Lafayette Hill, PA (US)

Correspondence Address: Lipsitz & McAllister, LLC, 755 MAIN STREET, MONROE, CT, 06468, US

(73) Assignee: General Instrument Corporation, Horsham, PA (US)

(21) Appl. No.: 10/718,074

(22) Filed: Nov. 20, 2003

(51) Int. Cl. H04N 7/16; H04H 9/00

(52) U.S. Cl. 725/15; 725/9

(57) ABSTRACT

Information related to signal quality on the downstream and upstream paths (104) in a cable network may be monitored (116, 208) at selected ones of a plurality of set-top boxes (110) and sent by the set-top box to the headend (102) as it is collected, or when the set-top box is polled by the headend. The information may be collected with the set-top box is in an idle state (204), by the set-top box tuning through the channels in the channel map (206) and by applying a time stamp to the information (208). Ping messages may be transmitted from the set-top box to the headend and back to the set-top box. Methods and apparatus are disclosed.

### FIELD OF THE INVENTION

The present invention relates to cable broadcasting systems and, more particularly, to monitoring the quality of signals on a cable television network or the like.

### BACKGROUND

Modem cable television networks include a return path and out-of-band (OOB) communications channels which enable a bi-directional flow of information between a subscriber's set-top box (STB) and the cable operator's headend. The operator maintains a distribution plant, and the cable network comprises many paths and nodes, ultimately ending at the subscriber level. Digital cable systems can make use of the cable return path and a cable modem in the set-top box to manage all downstream and upstream traffic to the set-top box. For example, the set-top box can contact the headend when the user purchases a pay-per-view event. The cable return path facilitates reportbacks, interactive applications, and sending program guide tuning data and other information to the set-top box. Cable reportbacks can either be initiated by the set-top box or polled via the headend as frequently as traffic on the system permits.

In most systems, cable operators are able to poll set-top boxes several times daily, in addition to reportback sessions initiated by the set-top boxes themselves. This helps keep billing records up-to-date while avoiding the bandwidth problems that could be caused by requiring an on-line connection for each pay-per-view purchase.

A basic set-top box (STB) includes a single, in-band (IB), tuner. The in-band tuner receives, e.g., MPEG-2 transport streams. These can include tables based upon standards such as the digital video broadcast (DVB) standard or the Advanced Television Systems Committee (ATSC) standard. Such a basic set-top box can receive analog or digital transmissions, on in-band (IB) channels, but cannot use the cable return path. A second tuner can be included in the STB if use of the cable return path is desired, or where out-of-band (OOB) channels will be used for communications between the headend and the set-top box.

The signals transmitted over the cable network (e.g., coaxial cable, fiber optic cable, a combination of coax and fiber, or the like) to the users may be degraded by various factors, not the least of which is faulty equipment. It is therefore important for the service operator to monitor signal quality and channel health (the characteristics of one channel may be different than those of another channel). Typically, this is done with dedicated, expensive equipment at various nodes in the cable network, and therefore cannot detect problems which may be as far down the network as at the subscriber level.

### SUMMARY OF THE INVENTION

An object of the invention is to provide an improved cable network and method of economically and efficiently detecting and diagnosing distribution plant faults and issues, all the way down the network from the headend to the subscriber level.

According to an embodiment of the invention, signal quality in a cable network is monitored at selected ones of a plurality of set-top boxes (STBs) which monitor and collect information about signal quality. This information may include at least one of channel absence/presence, error count and signal level estimates.

According to a feature of an embodiment of the invention, the information may be sent by the STB to the headend as it is collected, or when the STB is polled by the headend. The information may, for example, be collected when the STB is in an idle state, e.g., by having the STB tune through the channels in the channel map and by applying a time stamp to the information. Upon reaching a last channel in the channel map, the STB can enter a sleep mode for a given period of time, at the end of which time the STB resumes monitoring signals.

According to an aspect of an embodiment of the invention, ping messages may be transmitted from the STB to the headend and returned back to the STB. The ping message returned to the STB by the headend may comprise statistics about the signal that the headend received from the STB and, upon reception of the return ping message, the STB may verify functionality and record any appropriate signal statistics in its records.

Method and apparatus are disclosed.

### BRIEF DESCRIPTION OF THE DRAWINGS

FIG. 1 is a diagram illustrating a cable system appropriate for implementing an embodiment of the invention.

FIG. 2 is a flowchart illustrating an embodiment of the invention.

### DETAILED DESCRIPTION

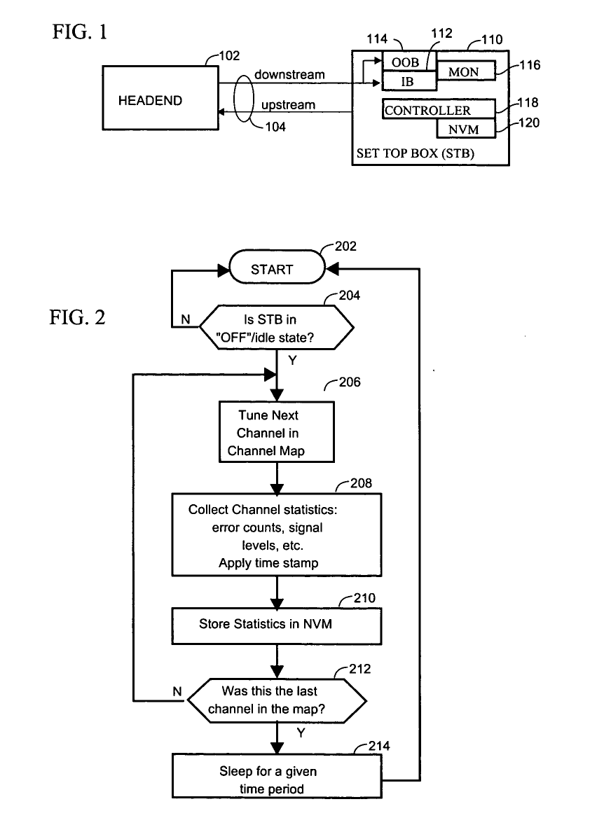

FIG. 1 illustrates, in simplified form, a cable system suitable for implementing an embodiment of the invention. A cable service operator (sometimes referred to as “MSO”, or multiple service operator) maintains a headend 102 and a network of cables 104. The headend is where the cable system receives services (e.g., television programming) from various sources, assigns the programming to channels and retransmits it onto the cables 104. A plurality of users (subscribers), one shown, each have set-top boxes (STBs) 110. The cable network 104 includes a downstream path for providing services/content (video programs, etc.) to the user and an upstream, or return path for allowing the set-top box 110 to transmit information to the cable headend 102. There is a bi-directional flow of information between the subscriber's set-top box 110 and the cable operator's headend 102. The set-top box 110 has more than one tuner (112, 114) so that it can receive out-of-band (OOB) communications simultaneously with in-band (IB) communications. This means that subscribers can be tuned to a channel receiving audio and video content while, at the same time, the STB 110 is receiving instructions in an OOB channel. The communications from the headend 102 to the STB 110 comprises the OOB channel(s) and a plurality of IB channels,. The STB maintains a channel map which is a listing of all of the channels.

The STB 110 comprises an in-band (IB) tuner 112 for receiving first signals from the cable operator, an out-of-band (OOB) tuner 114 for receiving second signals from the cable operator, a monitor (MON) 116 for generating information related to signal quality on the channels (either or both IB and OOB), a controller (CONTROLLER) 118 for controlling the overall operation of the STB, and non-volatile memory (NVM) 120 for storing information, particularly that information relating to signal quality which is gathered by the monitor (MON) 116. This signal quality information can include information about channel absence/presence, error count and signal level estimates. As described below, the information about signal quality can be transmitted by the STB to the headend either as it is collected, or when the STB is polled by the headend. The transmitter (e.g., modem) and other details of the STB, which are well known to those skilled in the art, are omitted for illustrative clarity.

FIG. 2 illustrates an embodiment of a program sub-routine running on the controller (118) for controlling the operation of the STB (110). The program starts (START) at a step 202. In a first step 204, it is determined whether the STB is in an “off” (or idle) state and, if not (N), the program loops until the STB is (Y) in the “off” (or idle) state. (The “off” state does not mean that the STB is unpowered, but rather that it is in a “wait” or “ready” state.) In a next step 206, the STB tunes a next channel in the channel map. In a next step 208, the STB collects channel statistics (information) such as error counts, signal levels, etc., and applies a time stamp to the information. In a next step 210, the statistics which have been collected are stored in NVM (120). Next, in a step 212 it is determined whether the channel currently being tuned is the last channel in the channel map and, if not (N), the program loops back to the step 206 to tune the next channel in the channel map until the last channel has been (Y) tuned. This provides coverage and health check for all of the channels. Then, in a step 214, the program goes into a sleep mode (pauses) for a given period of time, at the end of which it starts again at the step 202.

The invention therefore provides a method to allow a set-top box (STB) to collect statistics on plant health by monitoring the forward (downstream) and reverse (upstream, return path) transport cable signals, and reporting this information back to the cable headend.

The monitoring feature can operate automatically in the background so as not to disturb any viewer experiences; i.e., when the STB is turned “off” and in an idle state. The STB will collect statistics on plant health, as indicated by signal quality, on a channel-by-channel basis. It is within the scope of the invention that fewer than all of the channels are monitored. (The channel map can indicate which channels will be monitored.) These statistics can either be stored for future collection by the headend 102 via a two way polling mechanism, or the STB 110 can actively transmit (report, forward) the statistics back to the head-end as they are collected. Two-way polling can be implemented, for example, by polling the STB from the headend via the downstream path (typically on the OOB channel), and having the STB report back via the upstream path.

The monitoring feature can be activated any time the STB is in an idle state and not being used. In order to provide plant health monitoring, the STB can provide three main monitoring functions.
monitoring of errors/dropouts on the OOB control channel;
monitoring of errors/dropouts on the forward/downstream transport channel (mainly consisting of video services);
verification of return path health by transmission of ack/nack or “ping” messages from the STB to the headend and back

In order to monitor the forward transport, the STB can wait until the box is in an “off” state (see FIG. 2, step 204). In this mode, the STB will tune each channel in its channel map and monitor the channel's health for a period of time (channel absence/presence, error count, signal level estimates, etc.) and log this information with a timestamp. The STB can continue to cycle through the channel map at some periodicity and maintain the aforementioned statistics. See FIG. 2.

In order to monitor the reverse transport, the STB can transmit a “ping” type signal up the reverse/upstream path to the headend. The headend receives the transmitted ping signal and returns it as a return ping message to the STB via the OOB channel (transport). The return ping message may also contain statistics about the signal that the headend received from the STB, such as signal level, error count, etc. Upon reception of the round trip ping signal (i.e., the return ping message), the STB can verify functionality and record any appropriate signal statistics in its records.

All of this statistical information can be collected and transmitted to the headend (FIG. 1, 102) using a polling system. The headend can query the STB for a report of all of its health monitoring statistics. This information is then transmitted back to the headend on the reverse (upstream) transport path. If there is a plant failure of the reverse/upstream transport path, the STB will not be able to send its report. However, the headend will have an immediate indication of this since the STB did not respond to the query; Additionally, once the reverse path functionality is restored, the STB can again be polled. The headend can examine the statistics of the STB (as well as the timestamps) to determine when the plant went down. It can also be used to track/log intermittent outages.

It is, however, not necessary that each and every STB be set up to do monitoring (monitoring-enabled), or that all monitoring-enabled STBs associated with a single node be turned on (running the monitoring sub-routine of FIG. 2) at the same time. However, there should be at least one monitoring-enabled STB per node, and it should be turned on. When there are several monitoring-enabled STBs per node, one can be enabled (via a control signal from the headend over the OOB channel), and the other monitoring-enabled STBs associated with the node can be quiescent (set to not run the monitoring sub-routine). When a problem is detected at a subscriber's location (house), the monitoring function can be turned off at that STB from the headend and the monitoring function at the STB at a neighbor's house on the same node could be enabled. In this manner signal quality in the cable network can be efficiently and effectively monitored, all the way from the headend down to the subscriber level, in an efficient manner.

The invention has been illustrated and described in a manner that should be considered as exemplary rather than restrictive in character. Many modifications and adaptations may be made thereto without departing from the spirit and scope of the invention as set forth in the claims.

For example, in systems where the network has not been upgraded to support a cable return path, a telephone modem may be included in the set-top box for sending signal quality reports from the STB to the headend. Moreover, the STB could monitor only one channel, such as the OOB channel, without tuning through the channel map.

1. A method of monitoring signal quality in a cable network comprising a headend connected by a cable network to a plurality of set-top boxes (STBs), the method comprising:
at selected ones of the STBs, monitoring and collecting information about signals received by the STB.

2. A method according to claim 1, wherein the information comprises at least one of channel absence/presence, error count and signal level estimates.

3. A method according to claim 1, wherein the cable network includes a downstream path for providing services/content to the STBs and an upstream path allowing the STBs to transmit information which has been collected to the headend.

4. A method according to claim 1, wherein the STB comprises an in-band (IB) tuner for receiving first signals from the headend, an out of band (OOB) tuner for receiving second signals from the headend, a monitor (MON) for generating the information about at least one of the first and second signals received by the STB, a controller (CONTROLLER) for controlling the overall operation of the STB, and non-volatile memory (NVM) for storing the information about the first and second signals received by the STB.

5. A method according to claim 4, wherein the STB maintains a channel map, further comprising:
when the STB is in an idle state, at the STB, tuning through the channels in the channel map and collecting the information about the first and second signals received by the STB including applying a time stamp to the information.

6. A method according to claim 5, further comprising:
upon reaching a last channel in the channel map, entering a sleep mode for a given period of time, at the end of which time the STB resumes monitoring signals received by the STB.

7. A method of monitoring statistics about cable transmissions on a cable network comprising a headend and a plurality of set-top boxes (STBs), the method comprising:
using at least one of the plurality of STBs, collecting statistics on plant health by monitoring signals on downstream and upstream paths, and reporting information related to the quality of these signals from the STB back to the headend.

8. A method according to claim 7, further comprising:
performing the monitoring function in the background when the STB is not being used.

9. A method according to claim 7, further comprising:
storing the statistics for future collection via a two way polling mechanism.

10. A method according to claim 7, further comprising:
transmitting the statistics from the STB to the headend as they are collected.

11. A method according to claim 7, wherein the cable network includes an out-of-band (OOB) control channel, and further comprising:
at the STB, monitoring of errors/dropouts on the OOB control channel.

12. A method according to claim 7, further comprising:
monitoring errors/dropouts on the downstream path.

13. A method according to claim 7, further comprising:
transmitting ping messages from the STB to the headend and back to the STB.

14. A method according to claim 7, further comprising:
monitoring the downstream path, by waiting until the STB is in an off state, then tuning each channel in a channel map.

15. A method according to claim 14, further comprising:
monitoring each channel's health for a period of time and logging this information with a timestamp.

16. A method according to claim 15, further comprising:
monitoring a channel's health by monitoring at least one of channel absence/presence, error count and signal level estimates.

17. A method according to claim 14, further comprising:
cycling through the channel map at some periodicity.

18. A method according to claim 7, further comprising:
monitoring the upstream path by transmitting a “ping” type signal from the STB to the headend.

19. A method according to claim 18, further comprising:
at the head-end, receiving the transmitted ping signal and returning it to the STB via the downstream path.

20. A method according to claim 19, wherein:
the return ping message comprises statistics about the signal that the headend received from the STB.

21. A method according to claim 20, wherein:
upon reception of the return ping message, the STB verifies functionality and records any appropriate signal statistics in its records.

22. A method according to claim 7, further comprising:
collecting information at the STB and transmitting it from the STB to the headend using a polling system.

23. A method according to claim 22, wherein:
the information is transmitted to the head end on the upstream path.

24. A method according to claim 7, wherein the headend queries the STB for a report of channel health monitoring statistics.

25. A method according to claim 7, wherein:
the cable network comprises nodes, and
there is at least one monitoring-enabled STB per node.

26. A method according to claim 25, wherein:
when there are several monitoring-enabled STBs per node, a portion of the STBs are enabled and a remaining portion of the STBs are quiescent.

27. A method according to claim 26, further comprising:
from the headend, turning off the monitoring function of a monitoring-enabled STB and turning on the monitoring function of a quiescent STB on the same node.

28. Apparatus for monitoring signal quality in a cable network comprising a headend connected by cable to a plurality of set-top boxes (STBs), wherein at least one of the STBs comprises:
in-band tuner means for receiving first signals from the cable operator;
out-of-band tuner means for receiving second signals from the cable operator;
monitor means for generating information related to signal quality;
controller means for controlling the overall operation of the STB; and
non-volatile memory means for storing the information generated by the monitor means.

29. Apparatus according to claim 28, further comprising:
means for transmitting the information from the STB to the headend as it is collected.

30. Apparatus according to claim 28, further comprising:
means for transmitting the information from the STB to the headend when the STB is polled by the headend.
